(19) United States
(12) Patent Application Publication
(10) Pub. No.: US 2020/0245217 A1
(43) Pub. Date: Jul. 30, 2020

(54) CONTROL METHOD, UNMANNED AERIAL VEHICLE, SERVER AND COMPUTER READABLE STORAGE MEDIUM

(71) Applicant: SZ DJI TECHNOLOGY CO., LTD., Shenzhen (CN)

(72) Inventor: Xiao Zhang, Shenzhen (CN)

(21) Appl. No.: 16/842,215

(22) Filed: Apr. 7, 2020

Related U.S. Application Data
(63) Continuation of application No. PCT/CN2017/107285, filed on Oct. 23, 2017.

(51) Int. Cl. H04W 36/32; H04W 36/08; H04W 64/00; H04W 36/00; H04W 4/40; B64C 39/02; G05D 1/00; G05D 1/10

(52) U.S. Cl. CPC H04W 36/32; H04W 36/08; H04W 64/003; H04W 36/0079; B64C 2201/146; B64C 39/024; G05D 1/0022; G05D 1/101; B64C 2201/027; H04W 4/40

(57) ABSTRACT

A method for controlling an unmanned aerial vehicle (UAV) in communication with a first control base station includes obtaining position information of a second control base station, determining that a distance between the UAV and the second control base station is shorter than a distance between the UAV and the first control base station, and establishing a communication with the second control base station.

### CROSS-REFERENCE TO RELATED APPLICATION

This application is a continuation of International Application No. PCT/CN2017/107285, filed Oct. 23, 2017, the entire content of which is incorporated herein by reference.

### TECHNICAL FIELD

The present disclosure relates to communications technologies, more particularly, to a control method, an unmanned aerial vehicle, a server, and a computer readable storage medium.

### BACKGROUND

At present, the operation radius of unmanned aerial vehicles is limited to the radio frequency transmission power of the control base station.

### SUMMARY

In accordance with the disclosure, there is provided a method for controlling an unmanned aerial vehicle (UAV) in communication with a first control base station including obtaining position information of a second control base station, determining that a distance between the UAV and the second control base station is shorter than a distance between the UAV and the first control base station, and establishing a communication with the second control base station.

Also in accordance with the disclosure, there is provided a method for controlling a UAV including receiving information indicating that a distance between the UAV and a first control base station is greater than a distance between the UAV and a second control base station, receiving information about a communication state of the UAV being switched from communicating with the first control base station to communicating with the second control base station, and switching a data source from the first control base station to the second control base station.

Also in accordance with the disclosure, there is provided an unmanned aerial vehicle (UAV) in communication with a first control base station including a communication circuit configured to obtain position information of a second control base station and a processor configured to determine that a distance between the UAV and the second control base station is shorter than a distance between the UAV and the first control base station. The communication circuit is further configured to establish a communication with the second control base station.

Also in accordance with the disclosure, there is provided a server including a communication circuit configured to receive information indicating that a distance between an unmanned aerial vehicle (UAV) and a first control base station is greater than a distance between the UAV and a second control base station, receive information indicating that a communication state of the UAV is switched from communicating with the first control base station to communicating with the second control base station, and switch a data source from the first control base station to the second control base station.

### BRIEF DESCRIPTION OF THE DRAWINGS

FIG. 1 is a schematic flow chart of a control method according to some example embodiments of the present disclosure.

FIG. 2 is a schematic module diagram of a communication system according to some example embodiments of the present disclosure.

FIG. 3 is a schematic scene illustration of a control method according to some example embodiments of the present disclosure.

FIGS. 4-10 are schematic flow charts of control methods according to some example embodiments of the present disclosure.

FIG. 11 is a schematic module diagram of a communication system according to some example embodiments of the present disclosure.

FIGS. 12-14 are schematic flow charts of control methods according to some example embodiments of the present disclosure.

FIG. 15 is a schematic module diagram of a communication system according to some example embodiments of the present disclosure.

FIGS. 16-22 are schematic flow charts of control methods according to some example embodiments of the present disclosure.

### DETAILED DESCRIPTION OF THE EMBODIMENTS

Example embodiments will be described with reference to the accompanying drawings, in which the same numbers refer to the same or similar elements unless otherwise specified. The embodiments described below with reference to the drawings are exemplary and are only considered to explain the disclosure, and not to limit the scope of the disclosure.

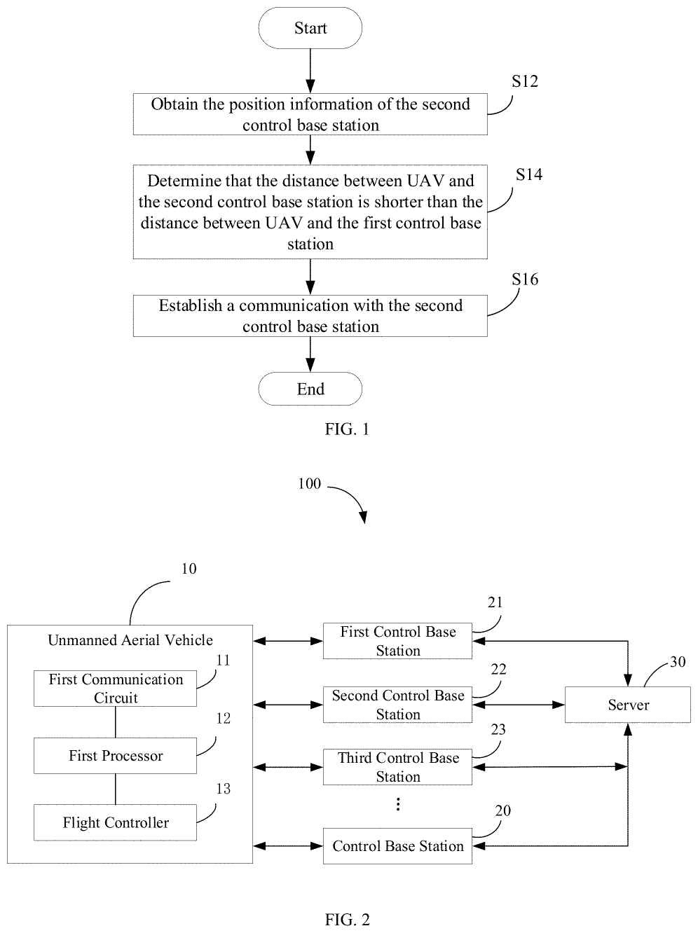

FIGS. 1 and 2 are schematic drawings of an example control method consistent with the disclosure. The control method is used for control of an unmanned aerial vehicle (UAV) 10 by at least two control base stations 20. The at least two control base stations 20 include a first control base station 21 having a fixed position and a second control base station 22 having a fixed position. The first control base station 21 is the control base station 20 currently in communication with the UAV 10. As shown in FIG. 1, at S12, location information of the second control base station 22 is obtained.

At S14, the distance between the UAV 10 and the second control base station 22 is determined to be shorter than the distance between the UAV 10 and the first control base station 21.

At S16, a communication with the second control base station 22 is established.

In the embodiments of the present disclosure, the control method can be implemented by the UAV 10 consistent with the disclosure and the at least two control base stations 20 control the UAV 10. The at least two control base stations 20 include the first control base station 21 and the second control base station 22, each having a fixed position. The first control base station 21 is the control base station 20 currently in communication with the UAV 10. The UAV 10 includes a first communication circuit 11 and a first processor 12. S12 and S16 can be implemented by the first communication circuit 11, and S14 can be implemented by the first processor 12.

That is, the first communication circuit 11 is configured to obtain the position information of the second control base station 22 and establish communication with the second control base station 22. The first processor 12 is configured to determine that the distance between the UAV 10 and the second control base station 22 is shorter than the distance between the UAV 10 and the first control base station 21. The UAV 10 can communicate with the control base station 20 through a wireless communication (for example, WiFi, etc.).

If the UAV 10 communicates with only one control base station 20 when performing a fight task (for example, a line inspection, etc.), then when the distance between the UAV 10 and the control base station 20 is long or terrain occlusion exists between the UAV 10 and the control base station 20, the communication signal between the UAV 10 and the control base station 20 is weak. The UAV 10 can only perform a return-home operation. Therefore, the operation radius of the UAV 10 is greatly limited.

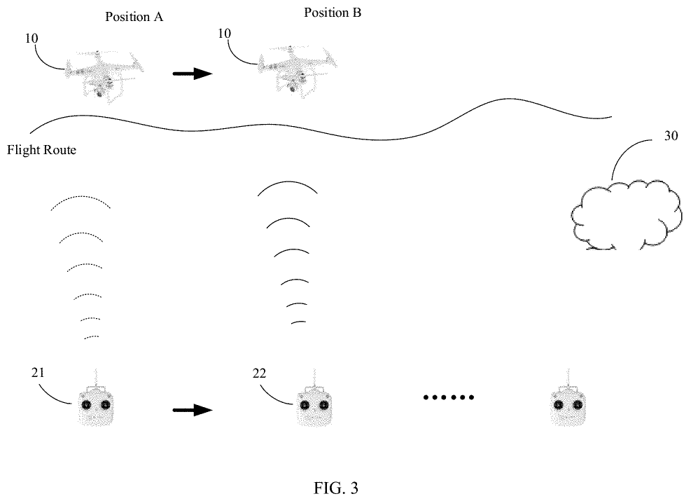

As shown in FIG. 3, a UAV 10 according to an embodiment of the present disclosure flies along a scheduled route and a plurality of control base stations 20 are numbered in a predetermined order, so that the communication of the UAV 10 can be switched. Specifically, the UAV 10 communicates with the first control base station 21 within a period of time after taking off. For example, the UAV 10 flies to position A. At this time, the distance between position A and the first control base station 21 is relatively short, so the UAV 10 communicates with the first control base station 21. As the UAV 10 continues to fly, the distance between the UAV 10 and the first control base station 21 becomes greater and greater. When the distance between the UAV 10 and the first control base station 21 is greater than a predetermined threshold (for example, the UAV 10 flies to position B), it can be considered that the communication signal between the UAV 10 and the first control base station 21 is already weak. The position information of the first control base station 21 is sent to the UAV 10 by the first control base station 21 in real time. In order to ensure a good communication between the UAV 10 and the control base stations 20, the UAV 10 obtains the position information of the second control base station 22 and establishes a communication with the second control base station 22 when the UAV 10 determines the distance between the UAV 10 and the second control base station 22 is shorter than the distance between the UAV 10 and the first control base station 21. Since the distance between the UAV 10 and the second control base station 22 is shorter than the distance between the UAV 10 and the first control base station 21, the communication signal between the UAV 10 and the second control base station 22 is stronger than the communication signal between the UAV 10 and the first control base station 21. Therefore, when the communication state of the UAV 10 is switched from communicating with the first control base station 21 to communicating with the second control base station 22, a good communication between the UAV 10 and the second control base station 22 can be maintained.

In addition, the UAV 10 can directly detect the strength of the communication signal between the UAV 10 and the first control base station 21 (for example, by detecting the signal-to-noise ratio, etc.), obtain position information of the first control base station 21 and the second control base station 22 when the strength of detected communication signal is weaker than a threshold, and then establish a communication with the second control base station 22 when the distance between the UAV 10 and the second control base station 22 is determined to be shorter than the distance between the UAV 10 and the first control base station 21. In some embodiments, the UAV 10 sends an instruction of inquiring the position information of the first control base station 21 to the first control base station 21 when the UAV 10 detects that the strength of the communication signal is weaker than a threshold, then the first control base station 21 sends its own position information to the UAV 10. In another way, the first control base station 21 can also send its own position information to the UAV 10 in real time, so that a good communication between the UAV 10 and the second control base station 22 can be maintained.

Each of the plurality of control base stations 20 communicates with a server 30. When the UAV 10 switches its communication state from communicating with the first control base station 21 to communicating with the second control base station 22, the UAV 10 sends the communication state to the server 30. Therefore when a user sends a control instruction to control the UAV 10 through the server 30, the server 30 can choose to forward the control instruction to the control base station 20 currently communicating with the UAV 10.

In the embodiments of the present disclosure, the control method and the UAV 10 use at least two control base stations 20 to communicate with the UAV 10. When the distance between the UAV 10 and the first control base station 21 is relatively long, the communication state can be switched from communicating with the first control base station 21 to communicating with the second control base station 22 so that the UAV 10 can maintain a good communication with the second control base station 22 that is closer to UAV 10. At a result, the operation radius of the UAV 10 is expanded.

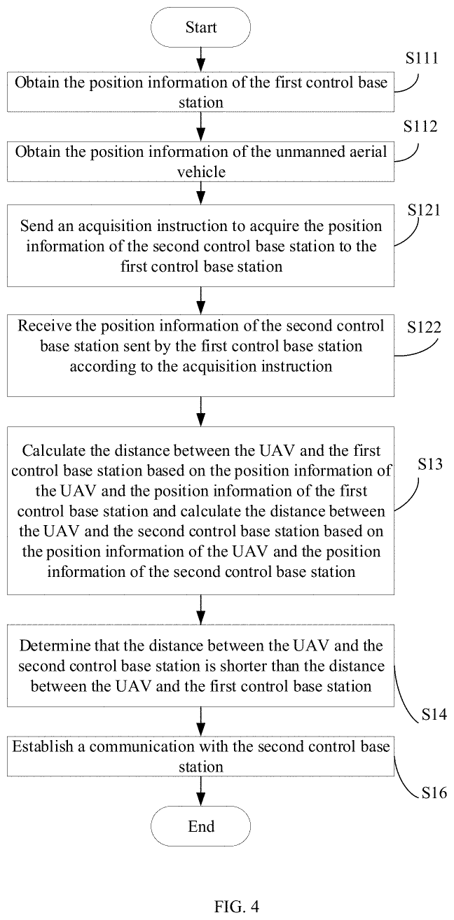

FIG. 4 is a schematic flow chart of an example control method consistent with the disclosure. As shown in FIG. 4, at S111, the position information of the first control base station 21 is obtained.

At S112, the position information of the UAV 10 is obtained.

At shown in FIG. 4, obtaining the position information of the second control base station 22 (S12 shown in FIG. 1) includes sending an acquisition instruction to acquire the position information of the second control base station 22 to the first control base station 21 (S121) and receiving the position information of the second control base station 22 sent by the first control base station 21 according to the acquisition instruction (S122).

Further, at S13, the distance between the UAV 10 and the first control base station 21 is calculated based on the position information of the UAV 10 and the position information of the first control base station 21, and the distance between the UAV 10 and the second control base station 22 is calculated based on the position information of the UAV 10 and the position information of the second control base station 22.

Referring to FIG. 2, in some embodiments, S111, S121, and S122 can be implemented by the first communication circuit 11, and S112 and S13 can be implemented by the first processor 12.

That is, the first communication circuit 11 can be further configured to acquire the position information of the first control base station 21 and send an acquisition instruction to acquire the position information of the second control base station 22 to the first control base station 21. The first processor 12 can be further configured to obtain position information of the UAV 10 and receive position information of the second control base station 22 sent by the first control base station 21 according to the acquisition instruction. The distance between the UAV 10 and the first control base station 21 is calculated based on the position information of the UAV 10 and the position information of the first control base station 21, and the distance between the UAV 10 and the second control base station 22 is calculated based on the position information of the UAV 10 and the position information of the second control base station 22.

The position information of the control base station 20 refers to the coordinates of the control base station 20. That is, the position information of the first control base station 21 refers to the coordinates of the first control base station 21, and the position information of the second control base station 22 refers to the coordinates of the second control base station 22. The position information of the UAV 10 refers to the coordinates of the UAV 10. Both coordinates of the control base station 20 and coordinates of the UAV 10 can be provided by a global satellite navigation system (e.g., Global Positioning System (GPS), Beidou Navigation Satellite System (BDS), Global Navigation Satellite System (GLONASS), etc.).

Specifically, the position information of the first control base station 21 can be sent to the UAV 10 in real time, or the first control base station 21 sends its own position information to the UAV 10 when the first communication circuit 11 of the UAV 10 sends an acquisition instruction to acquire the position information of the first control base station 21 to the first control base station 21. The position information of the UAV 10 can be read from a sensor by the first processor 12. The position information of the second control base station 22 is sent by the first control base station 21 to the UAV 10 when the first communication circuit 11 of the UAV 10 sends an acquisition instruction to acquire the position information of the second control base station 22 to the first control base station 21. In some embodiments, multiple control base stations 20 communicate with the server 30 (for example, the multiple control base stations 20 can communicate with the server 30 through a wired communication such as Ethernet), and position information of the multiple control base stations 20 are stored in the server 30. Therefore, when the first control base station 21 receives the acquisition instruction sent by the UAV 10 to obtain the position information of the second control base station 22, the first control base station 21 obtains the position information of the second control base station 22 from the server 30 and sends the position information to the UAV 10.

In some embodiments, the positions of the plurality of control base stations 20 are fixed, so the position information of the plurality of control base stations 20 can be stored in a memory (not shown in the figures) of the UAV 10. When the UAV 10 needs to acquire the position information of each control base station 20, the UAV 10 can directly read the position information from the memory via the first processor 12.

The order in which the UAV 10 acquires the position information of the first control base station 21, the position information of the second control base station 22, and its own position information can be arbitrary. For example, acquiring the position information may be in the order of acquiring the position information of the first control base station 21, acquiring the position information of the second control base station 22, and acquiring the position information of the UAV 10, or in the order of acquiring the position information of the UAV 10, acquiring the position information of the first control base station 21, and acquiring the position information of the second control base station 22, or the UAV 10 may obtain its own position information and the position information of the first control base station 21 at the same time, and then obtain the position information of the control base station 22. The order is not limited herein.

After the UAV 10 obtains the position information (e.g., coordinates) of the first control base station 21, the second control base station 22, and the UAV 10, the first processor 12 calculates the distance between the UAV 10 and the control base station 21 and the distance between the UAV 10 and the second control base station 22 based on the plurality of coordinates obtained above. The calculation of the distance between the UAV 10 and the first control base station 21 based on the position information of the UAV 10 and the position information of the first control base station 21 at S13 can be performed by calculating the distance between the coordinates of the UAV 10 and the coordinates of the first control base station 21. The calculation of the distance between the UAV 10 and the second control base station 22 based on the position information of the UAV 10 and the position information of the second control base station 22 at S13 can be performed by calculating the distance between the coordinates of the UAV 10 and the coordinates of the second control base station 22.

In this way, the UAV 10 can compare the distance between the UAV 10 and the first control base station 21 with the distance between the UAV 10 and the second control base station 22, and then switch the communication state from communicating with the first control base station 21 to communicating with the second control base station 22 to improve the communication quality when the distance between the UAV 10 and the second control base station 22 is shorter than the distance between the UAV 10 and the first control base station 21.

As shown in FIG. 5, establishing the communication with the second control base station 22 (S16 shown in FIG. 1) includes sending a communication request for establishing a communication to the second control base station 22 (S161) and establishing a communication with the second control base station 22 when the second control base station 22 agrees to establish a communication (S162).

Referring to FIG. 2, in some embodiments, S161 and S162 can be implemented by the first communication circuit 11. That is, the first communication circuit 11 can be further configured to send the communication request for establishing a communication to the second control base station 22 and establish the communication with the second control base station 22 when the second control base station 22 agrees to establish communication. Specifically, when the first processor 12 determines that the distance between the UAV 10 and the second control base station 22 is shorter than the distance between the UAV 10 and the first control base station 21, the first communication circuit 11 of the UAV 10 sends a communication request for establishing a communication to the second control base station 22. After the second control base station 22 receives the communication request for establishing a communication, if the second control base station 22 agrees to establish a communication, the second control base station 22 will send a feedback signal agreeing to establish a communication to the UAV 10. After receiving the feedback signal, the first communication circuit 11 of the UAV 10 switches the communication state from communicating with the first control base station 21 to communicating with the second control base station 22.

In some embodiments, during the entire flight of the UAV 10, the second control base station 22 is always on and receives external wireless signals in real time, so that the second control base station 22 can receive the communication request signal from the UAV 10 in time when the UAV 10 attempts to establish a communication with the second control base station 22.

In some other embodiments, the second control base station 22 can be in a standby state (the standby state refers to only being powered on, but not receiving external wireless signals). When the UAV 10 wishes to switch the communication state thereof from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to enable the function of receiving external wireless signals. Subsequently, the UAV 10 sends a wireless signal of the communication request for establishing a communication to the second control base station 22. After receiving the signal of the communication request, the second control base station 22 sends a feedback signal agreeing to establish a communication to the UAV 10. After receiving the feedback signal, the first communication circuit 11 of the UAV 10 can switch the communication state from communicating with the first control base station 21 to communicating with the second control base station 22.

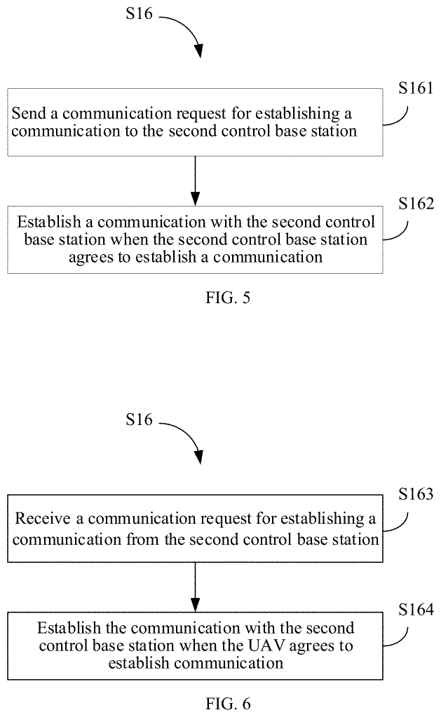

As shown in FIG. 6, establishing the communication with the second control base station 22 (S16 shown in FIG. 1) includes receiving a communication request for establishing a communication from the second control base station 22 (S163) and establishing the communication with the second control base station 22 when the UAV 10 agrees to establish communication (S164).

Referring to FIG. 2, in some embodiments, S163 and S164 can be implemented by the first communication circuit 11. That is, the first communication circuit 11 can be further configured to receive the communication request for establishing communication from the second control base station 22 and establish the communication with the second control base station 22 when the UAV 10 agrees to establish communication.

Specifically, during the entire flight of the UAV 10, the second control base station 22 sends a signal of a communication request for establishing communication in real time or every a short period of time. When the UAV 10 wishes to switch the communication state from communicating with the first control base station 21 to communicating with the second control base station 22, the first communication circuit 11 of the UAV 10 receives the communication request sent by the second control base station 22 and sends a feedback signal agreeing to establish communication to the second control base station 22. After receiving the feedback signal, the second control base station 22 maintains communication with the UAV 10 in real time.

In some other embodiments, when the UAV 10 wishes to switch the communication state from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to actively send a communication request for establishing a communication to the UAV 10. The first communication circuit 11 of the UAV 10 receives the communication request sent by the second control base station 22 and sends a feedback signal agreeing to establish a communication to the second control base station 22. After receiving the feedback signal, the second control base station 22 maintains communication with the UAV 10 in real time.

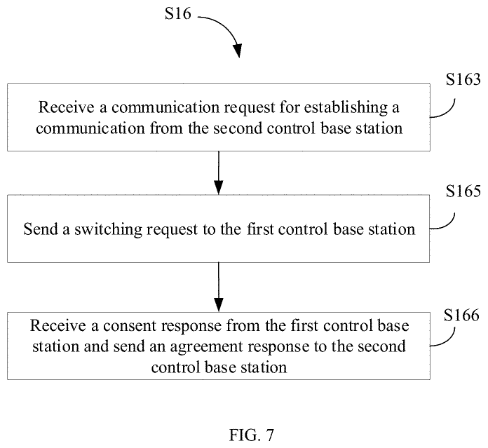

As shown in FIG. 7, establishing the communication with the second control base station 22 (S16 shown in FIG. 1) includes receiving a communication request for establishing communication from the second control base station 22 (S163), sending a switching request to the first control base station 21 (S165), receiving a consent response to the switching request from the first control base station 21, and sending an agreement response to the communication request to the second control base station 22 (S166).

Referring to FIG. 2, in some embodiments, S163, S165 and S166 can be implemented by the first communication circuit 11. That is, the first communication circuit 11 can be further configured to receive the communication request for establishing communication from the second control base station 22, send a switching request to the first control base station 21, receive the consent response to the switching request from the first control base station 21, and send the agreement response to the communication request to the second control base station 22.

Specifically, during the entire flight of the UAV 10, the second control base station 22 sends a signal of a communication request for establishing communication in real time or every a short period of time. When the UAV 10 wishes to switch the communication state from communicating with the first control base station 21 to communicating with the second control base station 22, the first communication circuit 11 of the UAV 10 receives the communication request sent by the second control base station 22, then the UAV 10 sends a switching request to the first control base station 21 after receiving the communication request and sends the agreement response to the communication request to the second control base station 22 after receiving the consent response to the switching request from the first control base station 21. Alternatively, when the UAV 10 wishes to switch the communication state from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to actively send a communication request for establishing communication to the UAV 10. After receiving the communication request, the UAV 10 sends a switching request to the first control base station 21 and sends the agreement response to the communication request to the second control base station 22 after receiving the consent response to the switching request from the first control base station 21. In some cases, when the UAV 10 is transmitting image data to the first control base station 21 and if the UAV 10 does not negotiate with the first control base station 21 to switch the control base station 20, then directly disconnecting the communication with the first control base station 21 by the UAV 10 will cause immediate interruption of image transmission and affect the continuity and real-time performance of the data transmission. In some other cases, when the user sends a control instruction for controlling the flight of the UAV 10 from the server 30 to the first control base station 21, and the first control base station 21 forwards the control instruction to the UAV 10, if the UAV 10 does not negotiate with the first control base station 21 about switching the control base station 20, directly disconnecting the communication with the first control base station 21 by the UAV 10 will affect the user's control of the UAV 10.

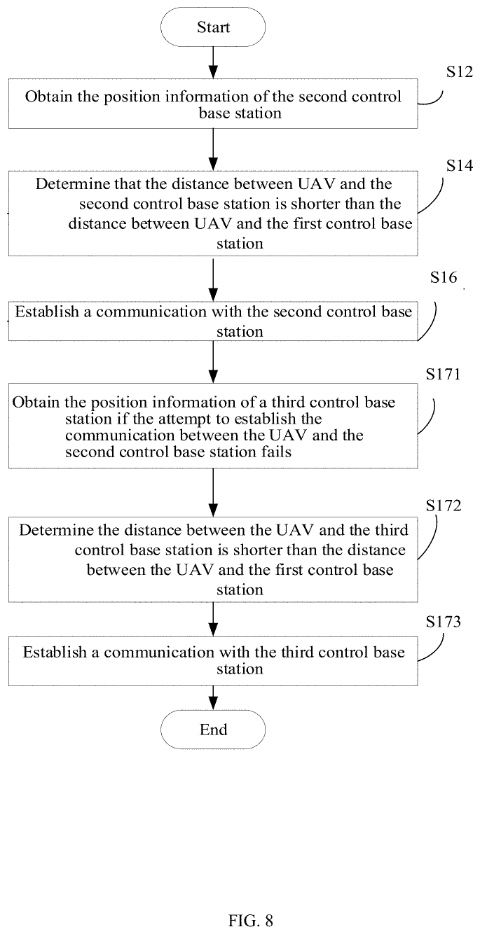

As shown in FIG. 8, in some embodiments, at S171, if the attempt to establish the communication between the UAV 10 and the second control base station 22 fails, the position information of a third control base station 23 is obtained.

At S172, the distance between the UAV 10 and the third control base station 23 is determined to be shorter than the distance between the UAV 10 and the first control base station 21.

At S173, a communication with the third control base station 23 is established.

Referring again to FIG. 2, in some embodiments, S171 and S173 can be implemented by the first communication circuit 11, and S172 can be implemented by the first processor 12.

That is, the first communication circuit 11 can be further configured to obtain the position information of the third control base station 23 when the attempt to establish the communication between the UAV 10 and the second control base station 22 fails, and establish a communication with the third control base station 23. The first processor 12 can be further configured to determine that the distance between the UAV 10 and the third control base station 23 is shorter than the distance between the UAV 10 and the first control base station 21.

The communication establishment failure between the UAV 10 and the second control base station 22 means the UAV 10 does not receive the feedback signal after the UAV 10 sends a communication request for establishing communication to the second control base station 22. It might be because the signal cannot be transmitted between the UAV 10 and the second control base station 22 at the moment, or the signal-to-noise ratio of the feedback signal from the second control base station 22 received by the UAV 10 is relatively low, making the communication quality between the UAV 10 and the second control base station 22 poor.

When terrain occlusion exists between the UAV 10 and the control base station 22, the communication signal between the UAV 10 and the control base station 22 becomes weak. Therefore, when the attempts to establish the communication between the UAV 10 and the second control base station 22 fails, the UAV 10 obtains the position information of the third control base station 23, and establishes a communication with the third control base station 23 when determining that the distance between the UAV 10 and the control base station 23 is shorter than the distance between the UAV 10 and the first control base station 21. The acquisition of the position information of the third control base station 23 is similar to the acquisition of the position information of the second control base station 22. The calculation of the distance between the UAV 10 and the third control base station 23 is similar to the calculation of the distance between the UAV 10 and the second control base station 22. The manner to establish communication between the UAV 10 and the third control base station 23 is similar to the manner to establish communication between the UAV 10 and the second control base station 22. The above methods will not be described again.

In this way, the UAV 10 switches the communication state from communicating with the first control base station 21 to communicating with the third control base station 23 so that the UAV 10 can maintain a good communication with the third control base station 23. Further, the UAV 10 sends the switching information of communication state to the server 30 through the third control base station 23.

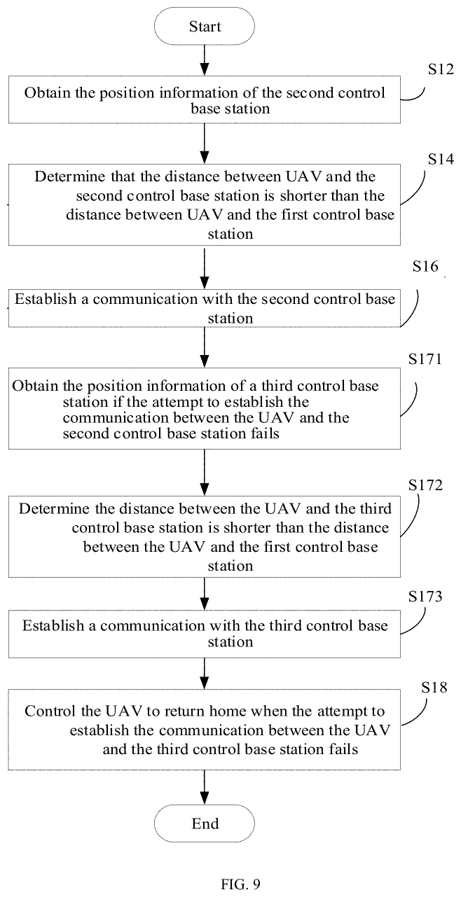

As shown in FIG. 9, in some embodiments, at S18, if the attempts to establish the communication between the UAV 10 and the third control base station 23 fails, the UAV 10 is controlled to return home.

Referring again to FIG. 2, in some embodiments, the UAV 10 further includes a flight controller 13. S18 can be implemented by the flight controller 13. That is, the flight controller 13 can be configured to control the UAV 10 to return home when the attempt to establish the communication between the UAV 10 and the third control base station 23 fails.

When the attempt to establish the communication between the UAV 10 and the third control base station 23 fails, if the UAV 10 continues to fly along the route, the distance between the UAV 10 and the first control base station 21 is getting longer and longer, and the communication signal between the UAV 10 and the first control base station 21 is getting weaker and weaker. However, the UAV 10 cannot find another control base station 20 to maintain a good communication between UAV 10 and the control base station 20. As such, a loss of connection with the UAV 10 may happen. Therefore, in order to ensure the safety of the UAV 10, when the attempt to establish the communication between the UAV 10 and the third control base station 23 fails, the flight controller 13 directly controls the UAV 10 to return home.

In some embodiments, when the attempt to establish the communication between the UAV 10 and the third control base station 23 fails, the UAV 10 can attempt to establish a communication with a fourth control base station 20 and also keep attempting to communicate with a fifth control base station 20 when the attempt to establish the communication between the UAV 10 and the fourth control base station 20 fails. The number of times that the UAV 10 attempts to establish a communication with the control base station 20 can be set by the user according to the actual situation.

The present disclosure further provides a computer-readable storage medium. The computer-readable storage medium stores a computer program to be used together with an electronic device, and the computer program can be executed by the first processor 12 to implement the control methods described in the above embodiments to control the UAV 10 by at least two control base stations 20. The electronic device is the UAV 10.

For example, the computer program can be executed by the first processor 12 to perform the control method by reading the position information of the second control base station 22 from the first communication circuit 11, determining that the distance between the UAV 10 and the second control base station 22 is shorter than the distance between the UAV 10 and the first control base station 21, and then controlling the first communication circuit 11 to establish communication with the second control base station 22.

For another example, the computer program can also be executed by the first processor 12 to perform the control method by reading the position information of the first control base station 21 from the first communication circuit 11, obtaining the position of the UAV 10 from the sensor, calculating the distance between the UAV 10 and the first control base station 21 based on the position information of the UAV 10 and the position information of the first control base station 21, and calculating the distance between the UAV 10 and the second control base station 22 based on the position information of the UAV 10 and the position information of the second control base station 22.

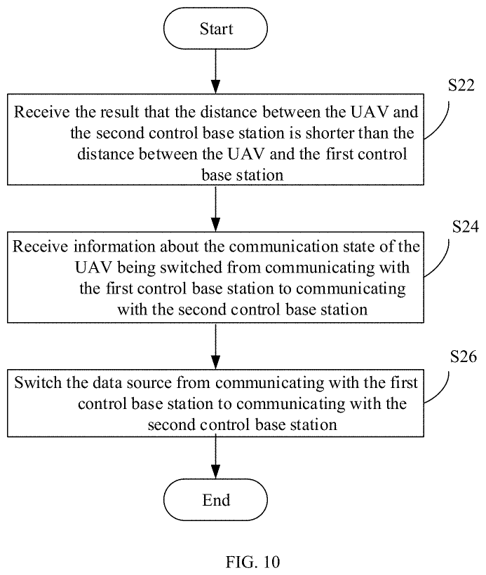

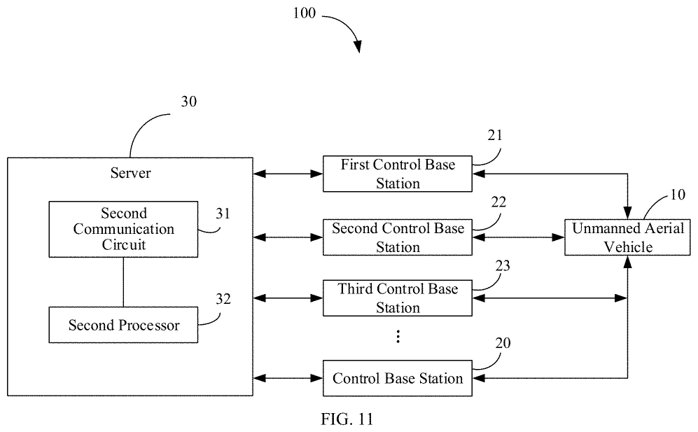

As shown in FIGS. 10 and 11, the present disclosure provides a control method for controlling the UAV 10 through at least two control base stations 20. The at least two control base stations 20 include a first control base station 21 having a fixed position and a second control base station 22 having a fixed position. The first control base station 21 is a control base station 20 currently communicating with the UAV 10.

At S22, the result that the distance between the UAV 10 and the second control base station 22 is shorter than the distance between the UAV 10 and the first control base station 21 is received.

At S24, information about the communication state of the UAV 10 being switched from communicating with the first control base station 21 to communicating with the second control base station 22 is received.

At S26, the data source is switched from communicating with the first control base station 21 to communicating with the second control base station 22.

In some embodiments, the control method can be implemented by the server 30. The server 30 controls the UAV 10 through at least two control base stations 20. The server 30 includes a second communication circuit 31. S22, S24, and S26 can be implemented by the second communication circuit 31.

That is, the second communication circuit 31 is further configured to receive the result that the distance between the UAV 10 and the second control base station 22 is shorter than the distance between the UAV 10 and the first control base station 21, receive information about the communication state of the UAV 10 being switched from communicating with the first control base station 21 to communicating with the second control base station 22, and switch the data source from the first control base station 21 to the second control base station 22.

Specifically, the server 30 remotely controls and monitors the UAV 10 through at least two control base stations 20. When the UAV 10 communicates with the first control base station 21, the server 30 controls the UAV 10 through the first control base station 21. When the UAV 10 communicates with the second control base station 22, the server 30 controls the UAV 10 through the second control base station 22. In another word, the server 30 controls the UAV 10 through the control base station 20 currently communicating with the UAV 10. Therefore, the server 30 must know which one of the plurality of control base stations 20 is the control base station 20 communicating with the UAV 10 at the current moment. Specifically, when the communication state of the UAV 10 is switched from communicating with the first control base station 21 to communicating with the second control base station 22, the UAV 10 will send the result that the distance between the UAV 10 and the second control base station 22 is shorter than the distance between the UAV 10 and the first control base station 21 and the switching information of communication state to the second control base station 22. The second control base station 22 forwards the result and the switching information to the server 30. Then the second communication circuit 31 of the server 30 receives the result and the switching information, and switches the data source from the first control base station 21 to the second control base station 22. As a result, the server 30 can have the flight status and communication status of the UAV 10 in real time.

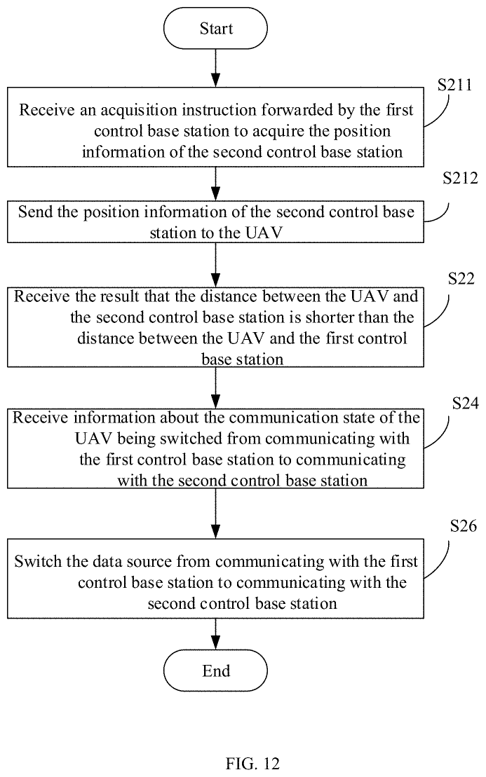

As shown is FIG. 12, in some embodiments, at S211, an acquisition instruction forwarded by the first control base station 21 to acquire the position information of the second control base station 22 is received. The acquisition instruction is sent by the UAV 10 to the first control base station 21.

At S212, the position information of the second control base station 22 is sent to the UAV 10.

Referring to FIG. 11, in some embodiments, S211 and S212 can be implemented by the second communication circuit 31. That is, the second communication circuit 31 can be further configured to receive the acquisition instruction forwarded by the first control base station 21 to acquire the position information of the second control base station 22 and send the position information of the second control base station 22 to the UAV 10. The acquisition instruction is sent by the UAV 10 to the first control base station 21.

Specifically, multiple control base stations 20 communicate with the server 30 (for example, the multiple control base stations 20 can communicate with the server 30 through a wired communication such as Ethernet), and position information of the multiple control base stations 20 are stored in the server 30. Therefore, the UAV 10 wishes to obtain the position information of the second control base station 22, the UAV 10 will sent an acquisition instruction to the first control base station 21 to acquire the position information of the second control base station 22 and the first control base station 21 will forward the acquisition instruction to the server 30. After receiving the acquisition instruction, the second communication circuit 31 of the serve 30 sends the position information of the second control base station 22 to the first control base station 21, and then the first control base station 21 forwards the position information to the UAV 10. As a result, the UAV 10 obtains the position information of the second control base station 22.

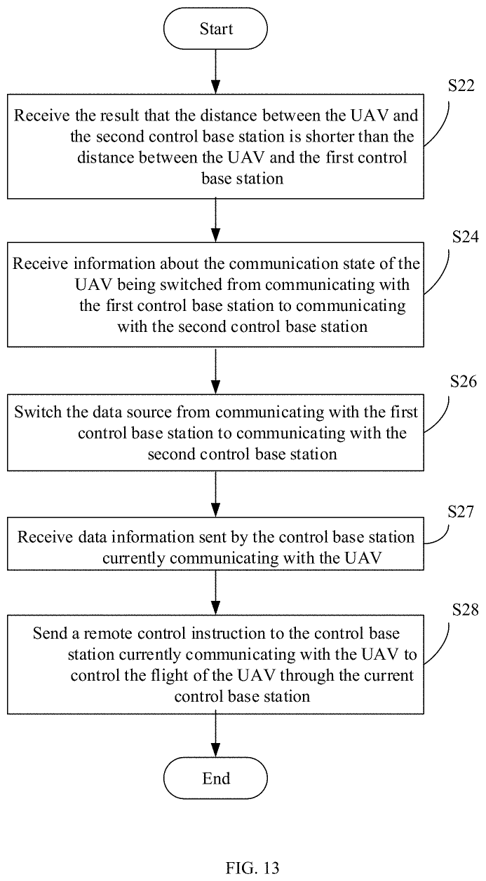

As shown in FIG. 13, in some embodiments, at S27, data information sent by the control base station 20 currently communicating with the UAV 10 is received. The data information is sent by the UAV 10 to the current control base station 20.

Referring to FIG. 11, in some embodiments, S27 can be implemented by the second communication circuit 31. That is, the second communication circuit 31 can be further configured to receive data information sent by the control base station 20 currently communicating with the UAV 10. The data information is sent by the UAV 10 to the current control base station 20.

The data information includes at least one of parameter information of the UAV 10, environmental information obtained by the UAV 10 through the load carried, or parameter information of the load carried by the UAV 10. In some embodiments, the data information can include only the parameter information of the UAV 10, or only the environmental information obtained by the UAV 10 through the load carried, or only the parameter information of the load carried by the UAV 10. In some embodiments, the data information can include both the parameter information of the UAV 10 and the environmental information obtained by the UAV 10 through the load carried, or include both the environmental information obtained by the UAV 10 through the load carried and the parameter information of the load carried by the UAV 10, or include both the parameter information of the UAV 10 and the parameter information of the load carried by the UAV 10. In some embodiments, the data information can include the parameter information of the UAV 10, the environmental information obtained by the UAV 10 through the load carried, and the parameter information of the load carried by the UAV 10 at the same time.

For example, the parameter information of the UAV 10 can include at least one of coordinates, pitch angle, flight speed, or battery power, the UAV 10. The environment information obtained by the UAV 10 through the load carried can include at least one of an image or a video captured by a camera carried by the UAV 10. The parameter information of the load carried by the UAV 10 can include the pitch angle of the gimbal carried by the UAV 10.

The UAV 10 sends the data information to the control base station 20 currently communicating with the UAV 10, and then the control base station 20 forwards the data information to the server 30. The second communication circuit 31 of the server 30 is responsible for receiving the above data information. As a result, the server 30 can fully appreciate the flight status of the UAV 10, which makes it convenient for the server 30 to remotely control the UAV 10.

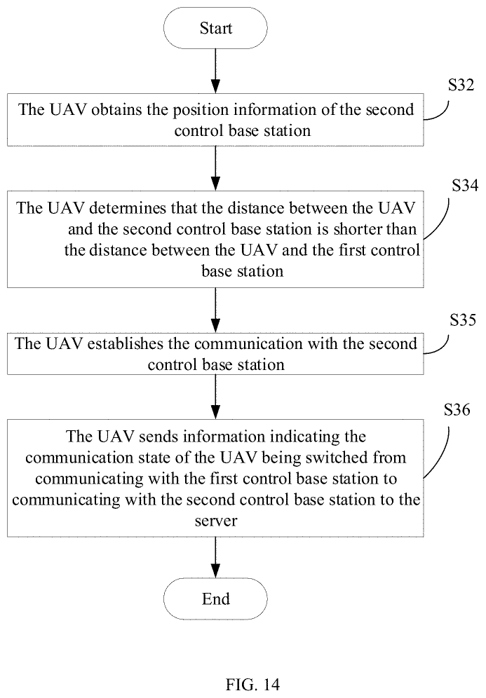

As shown in FIG. 14, in some embodiments, at S28, a remote control instruction is sent to the control base station 20 currently communicating with the UAV 10 to control the flight of the UAV 10 through the current control base station 20.

Referring to FIG. 11, in some embodiments, S28 can be implemented by the second communication circuit 31. The second communication circuit 31 can be further configured to send a remote control instruction to the control base station 20 currently communicating with the UAV 10 to control the flight of the UAV 10 through the current control base station 20.

Specifically, the user inputs a remote control instruction through an external device (such as a laptop computer, a tablet computer, a mobile phone, and etc.) that communicates with the server 30, and the server 30 sends the remote control instruction to the control base station 20 currently communicating with the UAV 10, and then the base station forwards the remote control instruction to the UAV 10. Therefore, when the UAV 10 performs a task, the user can remotely control the UAV 10 to fly and shoot images or videos of the target area through the server 30. In some unpredicted weather, the user can remotely control the UAV 10 through the server 30 to return and land in time to ensure the safety of the UAV 10.

The present disclosure also provides a computer-readable storage medium that stores a computer program to be used together with an electronic device. The computer program can be executed by the second processor 32 to implement the control method described in the above embodiments to control the UAV 10 by at least two control base stations 20. The electronic device is the server 30.

For example, the computer program can be executed by the second processor 32 to implement the control methods by controlling the second communication circuit 31 to receive the result that the distance between the UAV 10 and the second control base station 22 is shorter than the distance between the UAV 10 and the first control base station 21, receiving information about the communication state of the UAV 10 being switched from communicating with the first control base station 21 to communicating with the second control base station 22, and switching the data source from the first control base station 21 to the second control base station 22.

For another example, the computer program can also be executed by the second processor 32 to perform the control method by controlling the second communication circuit 31 to receive the acquisition instruction forwarded by the first control base station 21 to acquire the position information of the second control base station 22 and sending the position information of the second control base station 22 to the UAV 10. The acquisition instruction is sent by the UAV 10 to the first control base station 21.

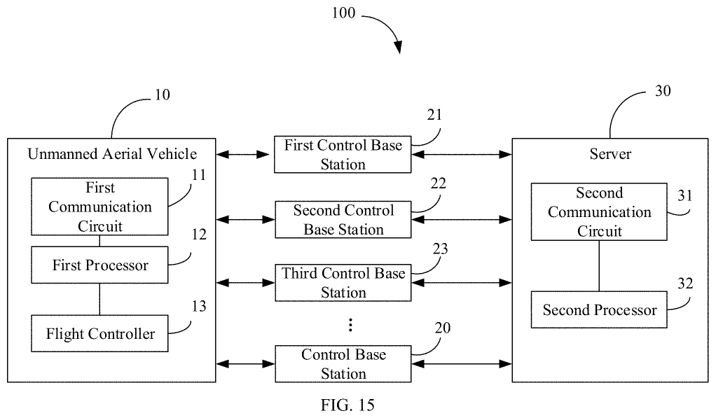

As shown in FIGS. 14 and 15, the present disclosure provides a control method used by the server 30 for controlling the UAV 10 through at least two control base stations 20. The at least two control base stations 20 include a first control base station 21 having a fixed position and a second control base station 22 having a fixed position. The first control base station 21 is a control base station 20 currently communicating with the UAV 10.

At S32, the UAV 10 obtains the position information of the second control base station 22.

At S34, the UAV 10 determines that the distance between the UAV 10 and the second control base station 22 is shorter than the distance between the UAV 10 and the first control base station 21.

At S35, the UAV 10 establishes the communication with the second control base station 22.

At S36, the UAV 10 sends information indicating the communication state of the UAV 10 being switched from communicating with the first control base station 21 to communicating with the second control base station 22 to the server 30.

Referring to FIG. 15, the control method according to the embodiments can be implemented by the communication system 100. The communication system 100 includes a UAV 10, a server 30, and at least two control base stations 20. The at least two control base stations 20 include a first control base station 21 and a second control base station 22, each having a fixed position. The first control base station 21 is a control base station 20 currently communicating with the UAV 10. The UAV 10 includes a first communication circuit 11 and a first processor 12. S32, S35, and S36 can be implemented by the first communication circuit 11. S24 can be implemented by the first processor 12.

The first communication circuit 11 can be further configured to obtain the position information of the second control base station 22, establish the communication with the second control base station 22, and send information indicating the communication state of the UAV 10 being switched from communicating with the first control base station 21 to communicating with the second control base station 22 to the server 30. The first processor 12 can be further configured to obtain the position information of the second control base station 22.

The UAV 10 can communicate with the control base station 20 through a wireless communication (for example, WiFi, etc.). The plurality of control base stations 20 can communicate with the server 30 through a wired communication such as Ethernet.

If the UAV 10 communicates with only one control base station 20 when performing a fight task (for example, a line inspection, etc.), then when the distance between the UAV 10 and the control base station 20 is long or terrain occlusion exists between the UAV 10 and the control base station 20, the communication signal between the UAV 10 and the control base station 20 is weak. The UAV 10 can only perform a return-home operation. Therefore, the operation radius of the UAV 10 is greatly limited. As shown in FIG. 3, a UAV 10 according to the embodiments of the present disclosure flies along a scheduled route and a plurality of control base stations 20 are numbered in a predetermined order, so that the communication state of the UAV 10 can be switched. Specifically, the UAV 10 communicates with the first control base station 21 within a period of time after taking off. For example, the UAV 10 flies to position A. At this time, the distance between position A and the first control base station 21 is relatively short, so the UAV 10 communicates with the first control base station 21. As the UAV 10 continues to fly, the distance between the UAV 10 and the first control base station 21 becomes greater and greater. When the distance between the UAV 10 and the first control base station 21 is greater than a predetermined threshold (for example, the UAV 10 flies to position B), it can be considered that the communication signal between the UAV 10 and the first control base station 21 is already weak. The position information of the first control base station 21 is sent to the UAV 10 by the first control base station 21 in real time. In order to ensure a good communication between the UAV 10 and the control base stations 20, the UAV 10 obtains the position information of the second control base station 22, establishes a communication with the second control base station 22 when the UAV 10 determines the distance between the UAV 10 and the second control base station 22 is shorter than the distance between the UAV 10 and the first control base station 21, and then sends the information indicating the communication state of the UAV 10 being switched from communicating with the first control base station 21 to communicating with the second control base station 22 to the server 30. Since the distance between the UAV 10 and the second control base station 22 is shorter than the distance between the UAV 10 and the first control base station 21, the communication signal between the UAV 10 and the second control base station 22 is stronger than the communication signal between the UAV 10 and the first control base station 21. Therefore, when the communication state of the UAV 10 is switched from communicating with the first control base station 21 to communicating with the second control base station 22, a good communication between the UAV 10 and the second control base station 22 can be maintained. Further, with the good communication between the UAV 10 and the second control base station 22, the UAV 10 can forward the data information to the server 30 through the second control base station 22, and the server 30 can forward the control instruction to the UAV 10 through the second control base station 22.

In addition, the UAV 10 can directly detect the strength of the communication signal between UAV 10 and the first control base station 21 (for example, by detecting the signal-to-noise ratio, etc.), obtain position information of the first control base station 21 and the second control base station 22 when the strength of detected communication signal is weaker than a threshold, establish a communication with the second control base station 22 when the distance between the UAV 10 and the second control base station 22 is determined to be shorter than the distance between the UAV 10 and the first control base station 21, and then send the UAV communication state being switched from communicating with the first control base station 21 to communicating with the second control base station 22 to the server 30. In some embodiments, the UAV 10 sends an instruction of acquiring the position information of the first control base station 21 to the first control base station 21 when the UAV 10 detects that the strength of the communication signal is weaker than a threshold, then the first control base station 21 sends its own position information to the UAV 10. In another way, the first control base station 21 can also send its own position information to the UAV 10 in real time, so that a good communication between the UAV 10 and the second control base station 22 can be maintained. Further, with the good communication between the UAV 10 and the second control base station 22, the UAV 10 can forward the data information to the server 30 through the second control base station 22, and the server 30 can forward the control instruction to the UAV 10 through the second control base station 22.

In the embodiments of the present disclosure, the control method and communication system 100 use at least two control base stations 20 to communicate with the UAV 10. When the distance between the UAV 10 and the first control base station 21 is relatively long, the communication state can be switched from communicating with the first control base station 21 to communicating with the second control base station 22 so that the UAV 10 can maintain a good communication with the second control base station 22 that is closer to the UAV 10. At a result, the operation radius of the UAV 10 is expanded.

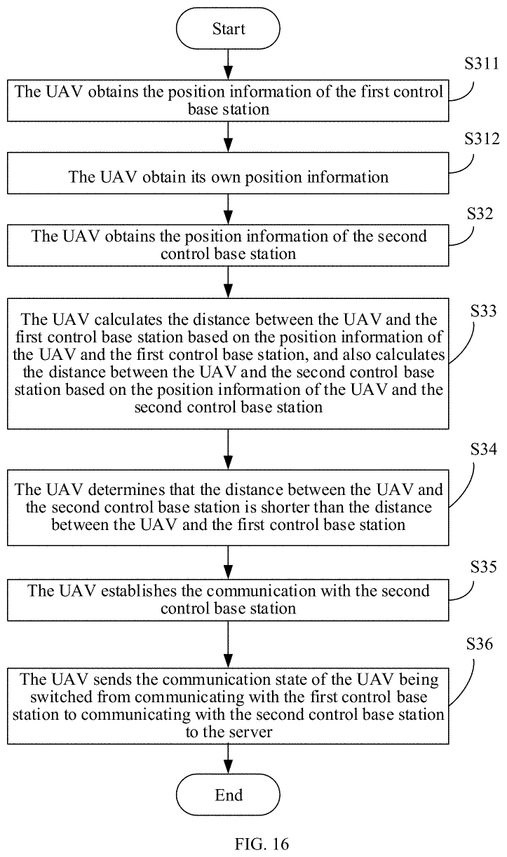

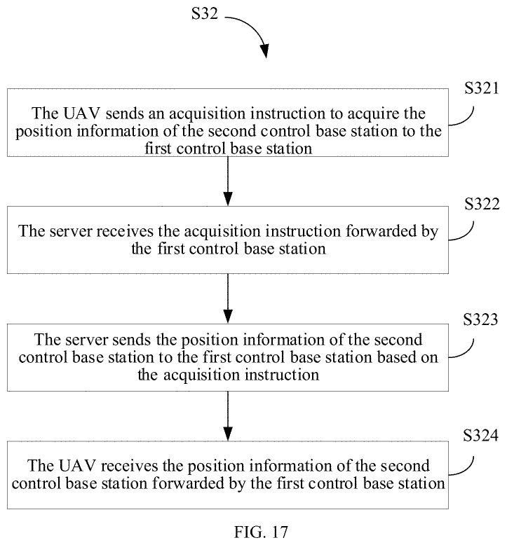

As shown in FIGS. 16 and 17, in some embodiments, at S311, the position information of the first control base station 21 is obtained.

At S312, the position information of the UAV 10 is obtained.

As shown in FIG. 17, obtaining the position information of the second control base station 22 by the UAV 10 (S32 shown in FIG. 16) includes the UAV 10 sending an acquisition instruction to acquire the position information of the second control base station 22 to the first control base station 21 (S321), the server 30 receiving the acquisition instruction forwarded by the first control base station 21 (S322), the server 30 sending the position information of the second control base station 22 to the first control base station 21 based on the acquisition instruction (S323), and the UAV 10 receiving the position information of the second control base station 22 forwarded by the first control base station 21 (S324).

Further, at S33, the UAV 10 calculates the distance between the UAV 10 and the first control base station 21 based on the position information of the UAV 10 and the first control base station 21, and also calculates the distance between the UAV 10 and the second control base station 22 based on the position information of the UAV 10 and the second control base station 22.

As shown in FIG. 15, in some embodiments, the sever 30 includes a second communication circuit 31. S311, S321 and S324 can be implemented by the first communication circuit 11. S322 and S323 can be implemented by the second communication circuit 31. S312 and S33 can be implemented by the first processor 12.

That is, the first communication circuit 11 can be further configured to obtain the position information of the first control base station 21, send an acquisition instruction to acquire the position information of the second control base station 22 to the first control base station 21, and receive the position information of the second control base station 22 forwarded by the first control base station 21. The first processor 12 can be further configured to obtain position information of the UAV 10, calculate the distance between the UAV 10 and the first control base station 21 based on the position information of the UAV 10 and the position information of the first control base station 21, and calculate the distance between the UAV 10 and the second control base station 22 based on the position information of the UAV 10 and the position information of the second control base station 22. The second communication circuit 31 is configured to receive the acquisition instruction forwarded by the first control base station 21, and send the position information of the second control base station 22 to the first control base station 21 based on the acquisition instruction.

The position information of the control base station 20 refers to the coordinates of the control base station 20. That is, the position information of the first control base station 21 refers to the coordinates of the first control base station 21, and the position information of the second control base station 22 refers to the coordinates of the second control base station 22. The position information of the UAV 10 refers to the coordinates of the UAV 10. Both coordinates of the control base station 20 and coordinates of the UAV 10 can be provided by a global satellite navigation system (e.g, Global Positioning System (GPS), Beidou Navigation Satellite System (BDS), Global Navigation Satellite System (GLONASS), etc.).

Specifically, the position information of the first control base station 21 can be sent to the UAV 10 in real time, or the first control base station 21 sends its own position information to the UAV 10 when the first communication circuit 11 of the UAV 10 sends an acquisition instruction to acquire the position information of the first control base station 21 to the first control base station 21. The position information of the UAV 10 can be read from a sensor by the first processor 12. The position information of the second control base station 22 is sent by the first control base station 21 to the UAV 10 when the first communication circuit 11 of the UAV 10 sends an acquisition instruction to acquire the position information of the second control base station 22 to the first control base station 21. In some embodiments, position information of the multiple control base stations 20 are stored in the server 30. Therefore, when the first control base station 21 receives the acquisition instruction sent by the UAV 10 to obtain the position information of the second control base station 22, the first control base station 21 forwards the acquisition instruction to acquire the position information of the second control base station 22 to the server 30. After receiving the acquisition instruction, the second communication circuit 31 of the server 30 sends the position information of the second control base station 22 to the first control base station 21, and then the first control base station 21 forwards the position information to the UAV 10.

In some embodiments, the positions of the plurality of control base stations 20 are fixed, so the position information of the plurality of control base stations 20 can be stored in a memory (not shown in the figures) of the UAV 10. When the UAV 10 needs to acquire the position information of each control base station 20, the UAV 10 can directly read the position information from the memory via the first processor 12.

The order in which the UAV 10 acquires the position information of the first control base station 21, the position information of the second control base station 22, and its own position information can be arbitrary. For example, acquiring the position information may be in the order of acquiring the position information of the first control base station 21, acquiring the position information of the second control base station 22, and acquiring the position information of the UAV 10, or in the order of acquiring the position information of the UAV 10, acquiring the position information of the first control base station 21, and acquiring the position information of the second control base station 22, or the UAV 10 may obtain its own position information and the position information of the first control base station 21 at the same time, and then obtain the position information of the second control base station 22. The order is not limited herein.

After the UAV 10 obtains the position information (i.e., coordinates) of the first control base station 21, the second control base station 22, and the UAV 10 itself, the first processor 21 can calculate the distance between the UAV 10 and the first control base station 21, and the distance between the UAV 10 and the second control base station 22 based on the multiple coordinates. At S33, the UAV 10 calculates the distance between the UAV 10 and the first control base station 21 based on the position information of the UAV 10 and the position information of the first control base station 21 by calculating the distance between the coordinates of the UAV 10 and the coordinates of the first control base station 21. At S33, the UAV 10 calculates the distance between the UAV 10 and the second control base station 22 based on the position information of the UAV 10 and the position information of the second control base station 22 by calculating the distance between the coordinates of the UAV 10 and the coordinates of the second control base station 22.

In this way, the UAV 10 can compare the distance between UAV 10 and the first control base station 21 with the distance between UAV 10 and the second control base station 22, and then switch the communication state from communicating with the first control base station 21 to communicating with the second control base station 22 to improve the communication quality when the distance between UAV 10 and the second control base station 22 is shorter than UAV 10 and the first control base station 21.

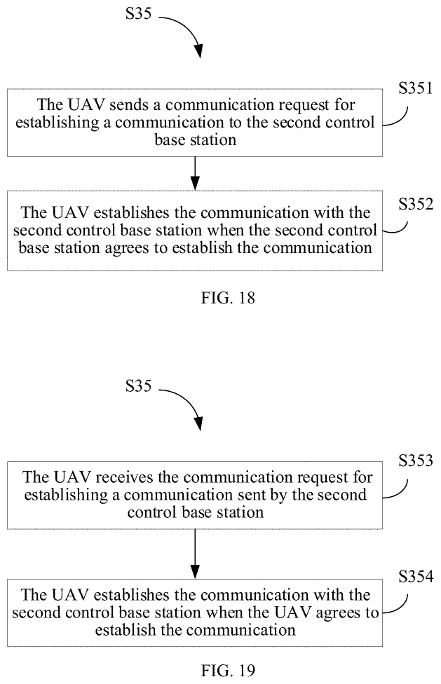

As shown in FIG. 18, in some embodiments, establishing the communication with the second control base station 22 by the UAV 10 (S35 shown in FIG. 16) includes the UAV 10 sending a communication request for establishing a communication to the second control base station 22 (S351) and the UAV 10 establishing a communication with the second control base station 22 when the second control base station 22 agrees to establish a communication (S352).

Referring to FIG. 15, in some embodiments, S351 and S352 can be implemented by the first communication circuit 11. That is, the first communication circuit 11 can be further configured to send the communication request for establishing a communication to the second control base station 22 and establish the communication with the second control base station 22 when the second control base station 22 agrees to establish communication.

Specifically, when the first processor 12 determines that the distance between the UAV 10 and the second control base station 22 is shorter than the distance between the UAV 10 and the first control base station 21, the first communication circuit 11 of the UAV 10 sends a communication request for establishing a communication to the second control base station 22. After the second control base station 22 receives the communication request for establishing a communication, if the second control base station 22 agrees to establish a communication, the second control base station 22 will send a feedback signal agreeing to establish a communication to the UAV 10. After receiving the feedback signal, the first communication circuit 11 of the UAV 10 switches the communication state from communicating with the first control base station 21 to communicating with the second control base station 22.

In some embodiments, during the entire flight of the UAV 10, the second control base station 22 is always on and receives external wireless signals in real time, so that the second control base station 22 can receive the communication request signal from the UAV 10 in time when the UAV 10 attempts to establish a communication with the second control base station 22.

In some other embodiments, the second control base station 22 can be in a standby state (the standby state refers to only being powered on, but not receiving external wireless signals). When the UAV 10 wishes to switch the communication state from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to enable the function of receiving external wireless signals. Subsequently, the UAV 10 sends a wireless signal of the communication request for establishing a communication to the second control base station 22. After receiving the signal of the communication request, the second control base station 22 sends a feedback signal agreeing to establish a communication to the UAV 10. The first communication circuit 11 of the UAV 10 switches the communication state from communicating with the first control base station 21 to communicating with the second control base station 22 after receiving the feedback signal.

As shown in FIG. 19, in some embodiments, establishing the communication with the second control base station 22 by the UAV 10 (S35 shown in FIG. 16) includes the UAV 10 receiving the communication request for establishing a communication sent by the second control base station 22 (S353) and the UAV 10 establishing a communication with the second control base station 22 when the UAV 10 agrees to establish a communication (S354).

Referring to FIG. 15, in some embodiments, S353 and S354 can be implemented by the first communication circuit 11. That is, the first communication circuit 11 can be further configured to receive the communication request for establishing a communication sent by the second control base station 22 and establish a communication with the second control base station 22 when the UAV 10 agrees to establish a communication.

Specifically, during the entire flight of the UAV 10, the second control base station 22 sends a signal of a communication request for establishing a communication in real time or every a short period of time. When the UAV 10 wishes to switch the communication state from communicating with the first control base station 21 to communicating with the second control base station 22, the first communication circuit 11 of the UAV 10 receives the communication request sent by the second control base station 22 and sends a feedback signal agreeing to establish communication to the second control base station 22. After receiving the feedback signal, the second control base station 22 maintains communication with the UAV 10 in real time.

In some other embodiments, when the UAV 10 wishes to switch the communication state from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to actively send a communication request for establishing a communication to the UAV 10. The first communication circuit 11 of the UAV 10 receives the communication request sent by the second control base station 22 and sends a feedback signal agreeing to establish a communication to the second control base station 22. After receiving the feedback signal, the second control base station 22 maintains communication with the UAV 10 in real time.

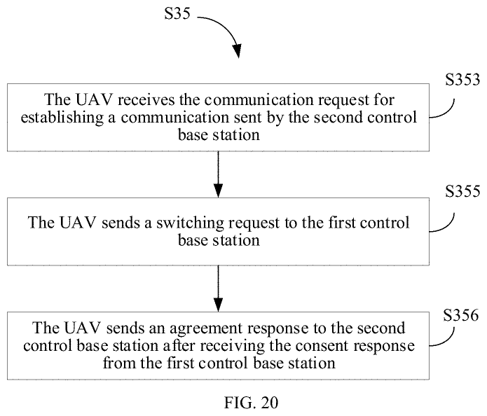

As shown in FIG. 20, in some embodiments, establishing a communication with the second control base station 22 by the UAV 10 (S35 shown in FIG. 16) includes the UAV 10 receiving the communication request for establishing a communication sent by the second control base station 22 (S353), the UAV 10 sending a switching request to the first control base station 21 (S355), and the UAV 10 sending an agreement response to the communication request to the second control base station 22 after receiving the consent response to the switching request from the first control base station 21 (S356).

Referring to FIG. 15, in some embodiments, S353, S355 and S356 can be implemented by the first communication circuit 11. That is, the first communication circuit 11 can be further configured to receive the communication request for establishing a communication sent by the second control base station 22, send a switching request to the first control base station 21, and send an agreement response to the communication request to the second control base station 22 after receiving the consent response to the switching request from the first control base station 21.

Specifically, during the entire flight of the UAV 10, the second control base station 22 sends a signal of a communication request for establishing a communication in real time or every short period of time. When the UAV 10 wishes to switch the communication state from communicating with the first control base station 21 to communicating with the second control base station 22, the first communication circuit 11 of the UAV 10 receives the communication request sent by the second control base station 22, then the UAV 10 sends a switching request to the first control base station 21 after receiving the communication request and sends the agreement response to the communication request to the second control base station 22 when receiving the consent response to the switching request from the first control base station 21. Alternatively, when the UAV 10 wishes to switch the communication state from communicating with the first control base station 21 to communicating with the second control base station 22, the UAV 10 sends a prompt signal to the first control base station 21, the first control base station 21 sends the prompt signal to the server 30, and then the server 30 sends the prompt signal to the second control base station 22 to prompt the second control base station 22 to actively send a communication request for establishing communication to the UAV 10. After receiving the communication request, the UAV 10 sends a switching request to the first control base station 21 and sends the agreement response to the communication request to the second control base station 22 when receiving the consent response to the switching request from the first control base station 21. In some cases, when the UAV 10 is transmitting image data to the first control base station 21 and if the UAV 10 does not negotiate with the first control base station 21 to switch the control base station 20, then directly disconnecting the communication with the first control base station 21 by the UAV 10 will cause immediate interruption of image transmission and affect the continuity and real-time performance of the data transmission. In some other cases, when the user sends a control instruction for controlling the flight of the UAV 10 from the server 30 to the first control base station 21, and the first control base station 21 forwards the control instruction to the UAV 10, if the UAV 10 does not negotiate with the first control base station 21 about switching the control base station 20, directly disconnecting the communication with the first control base station 21 by the UAV 10 will affect the user's control of the UAV 10.

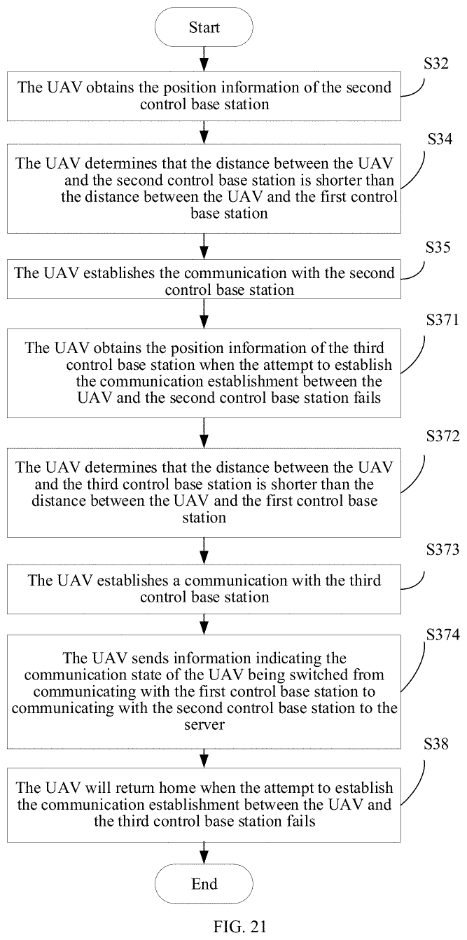

As shown in FIG. 21, in some embodiments, at S371, when the attempt to establish the communication between the UAV 10 and the second control base station 22 fails, the UAV 10 obtains the position information of the third control base station 23.

At S372, the UAV 10 determines that the distance between the UAV 10 and the third control base station 23 is shorter than the distance between the UAV 10 and the first control base station 21.

At S373, the UAV 10 establishes a communication with the third control base station 23.

At S374, the UAV 10 sends information indicating the communication state of the UAV 10 being switched from communicating with the first control base station 21 to communicating with the second control base station 22 to the server 30.

Referring to FIG. 15, in some embodiments, S371, S373, and S374 can be implemented by the first communication circuit 11, and S372 can be implemented by the first processor 12.

That is, the first communication circuit 11 can be further configured to obtain the position information of the third control base station 23 when the attempt to establish the communication between the UAV 10 and the second control base station 22 fails, establish a communication with the third control base station 23, and send information indicating the communication state of the UAV 10 being switched from communicating with the first control base station 21 to communicating with the second control base station 22 to the server 30. The first processor 12 can be further configured to determine that the distance between the UAV 10 and the third control base station 23 is shorter than the distance between the UAV 10 and the first control base station 21.

The communication establishment failure between the UAV 10 and the second control base station 22 means the UAV 10 does not receive the feedback signal from the second control base station 22 after the UAV 10 sends a communication request for establishing a communication to the second control base station 22. It might be because the signal cannot be transmitted between the UAV 10 and the second control base station 22 at the moment, or the signal-to-noise ratio of the feedback signal from the second control base station 22 received by the UAV 10 is relatively low, making the communication quality between the UAV 10 and the second control base station 22 poor.

When terrain occlusion exists between the UAV 10 and the control base station 22, the communication signal between the UAV 10 and the control base station 22 becomes weak. Therefore, when the attempt to establish the communication between the UAV 10 and the second control base station 22 fails, the UAV 10 obtains the position information of the third control base station 23, and establishes a communication with the third control base station 23 after determining that the distance between UAV 10 and the control base station 23 is shorter than the distance between the UAV 10 and the first control base station 21. The acquisition of the position information of the third control base station 23 is similar to the acquisition of the position information of the second control base station 22. The calculation of the distance between the UAV 10 and the third control base station 23 is similar to the calculation of the UAV 10 and the second control base station 22. The manner to establish communication between the UAV 10 and the third control base station 23 is similar to the manner to establish communication between the UAV 10 and the second control base station 22. The above methods will not be described again.

In this way, the UAV 10 switches the communication state from the communicating with first control base station 21 to communicating with the third control base station 23 so that the UAV 10 can maintain a good communication with the third control base station 23. Further, the UAV 10 sends the switching information of communication state to the server 30 through the third control base station 23. As a result, the UAV 10 can send data to the server 30 through the third control base station 23, and the server 30 can forward the control instruction to the UAV 10 through the control base station 23.

As shown in FIG. 21, in some embodiments, at S38, when the attempt to establish the communication between the UAV 10 and the third control base station 23 fails, the UAV 10 will return home.

As shown in FIG. 15, in some embodiments, the UAV 10 further includes a flight controller 13. The flight controller 13 can be further configured to control the UAV 10 to return home if the attempt to establish the communication between the UAV 10 and the third control base station 23 fails.

When the attempt to establish the communication between the UAV 10 and the third control base station 23 fails, if the UAV 10 continues to fly along the route, the distance between the UAV 10 and the first control base station 21 is getting longer and longer, and the communication signal between the UAV 10 and the first control base station 21 is getting weaker and weaker. However, the UAV 10 cannot find another control base station 20 to maintain a good communication between UAV 10 and the control base station 20. As such, a loss of connection with the UAV 10 may happen. Therefore, in order to ensure the safety of the UAV 10, when the attempt to establish the communication between the UAV 10 and the third control base station 23 fails, the flight controller 13 directly controls the UAV 10 to return home.

In some embodiments, when the attempt to establish the communication between the UAV 10 and the third control base station 23 fails, the UAV 10 can attempt to establish a communication with a fourth control base station 20 and also keep attempting to communicate a the fifth control base station 20 when the attempt to establish the communication between the UAV 10 and the fourth control base station 20 fails. The number of times that the UAV 10 attempts to establish a communication with the control base station 20 can be set by the user according to the actual situation.

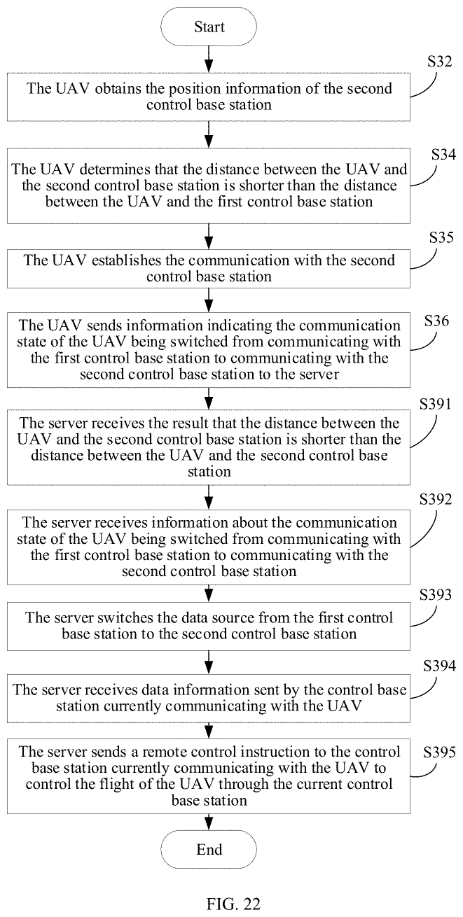

As shown in FIG. 22, in some embodiments, at S391, the server 30 receives the result that the distance between the UAV 10 and the second control base station 22 is shorter than the distance between the UAV 10 and the first control base station 21.

At S392, the server 30 receives information about the communication state of the UAV 10 being switched from communicating with the first control base station 21 to communicating with the second control base station 22.

At S393, the server 30 switches the data source from the first control base station 21 to the second control base station 22.

Referring to FIG. 15, in some embodiments, S391, S392, and S393 can be implemented by the second communication circuit 31. That is, the second communication circuit 31 is further configured to receive the result that the distance between the UAV 10 and the second control base station 22 is shorter than the distance between the UAV 10 and the first control base station 21, receive information about the communication state of the UAV 10 being switched from communicating with the first control base station 21 to communicating with the second control base station 22, and switch the data source from the first control base station 21 to the second control base station 22.

Specifically, the server 30 remotely controls and monitors the UAV 10 through at least two control base stations 20. When the UAV 10 communicates with the first control base station 21, the server 30 controls the UAV 10 through the first control base station 21. When the UAV 10 communicates with the second control base station 22, the server 30 controls the UAV 10 through the second control base station 22. In another word, the server 30 controls the UAV 10 through the control base station 20 currently communicating with the UAV 10. Therefore, the server 30 must know which one of the plurality of control base stations 20 is the control base station 20 communicating with the UAV 10 at the current moment. Specifically, when the communication state of the UAV 10 is switched from communicating with the first control base station 21 to communicating with the second control base station 22, the UAV 10 will send the result that the distance between the UAV 10 and the second control base station 22 is shorter than the distance between the UAV 10 and the first control base station 21 and the switching information of communication state to the second control base station 22. The second control base station 22 forwards the result and the switching information to the server 30. Then the second communication circuit 31 of the server 30 receives the result and the switching information, and switches the data source from the first control base station 21 to the second control base station 22. As a result, the server 30 can have the flight status and communication status of the UAV 10 in real time.

As shown in FIG. 22, in some embodiments, at S394, the server 30 receives data information sent by the control base station 20 currently communicating with the UAV 10. The data information is sent by the UAV 10 to the current control base station 20.

Referring to FIG. 15, in some embodiments, S394 can be implemented by the second communication circuit 31. That is, the second communication circuit 31 can be further configured to receive data information sent by the control base station 20 currently communicating with the UAV 10. The data information is sent by the UAV 10 to the current control base station 20.

The data information includes at least one of parameter information of the UAV 10, environmental information obtained by the UAV 10 through the load carried, or parameter information of the load carried by the UAV 10. In some embodiments, the data information can include only the parameter information of the UAV 10, or only the environmental information obtained by the UAV 10 through the load carried, or only the parameter information of the load carried by the UAV 10. In some embodiments, the data information can include both the parameter information of the UAV 10 and the environmental information obtained by the UAV 10 through the load carried, or include both the environmental information obtained by the UAV 10 through the load carried or the parameter information of the load carried by the UAV 10, or include both the parameter information of the UAV 10 and the parameter information of the load carried by the UAV 10. In some embodiments, the data information can include the parameter information of the UAV 10, the environmental information obtained by the UAV 10 through the load carried, and the parameter information of the load carried by the UAV 10 at the same time.

For example, the parameter information of the UAV 10 can include at least one of coordinates, pitch angles, flight speed, or battery power, of the UAV 10. The environment information obtained by the UAV 10 through the load carried can include at least an image or a video captured by a camera carried by the UAV 10. The parameter information of the load carried by the UAV 10 can include the pitch angle of the gimbal carried by the UAV 10.

The UAV 10 sends data information to the control base station 20 currently communicating with the UAV 10, and then the control base station 20 forwards the data information to the server 30. The second communication circuit 31 of the server 30 is responsible for receiving the above data information. As a result, the server 30 can fully appreciate the flight status of the UAV 10, which makes it convenient for the server 30 to remotely control the UAV 10.

As shown in FIG. 22, in some embodiments, at S395, the server 30 sends a remote control instruction to the control base station 20 currently communicating with the UAV 10 to control the flight of the UAV 10 through the current control base station 20.

Referring to FIG. 15, in some embodiments, S395 can be implemented by the second communication circuit 31. That is, the second communication circuit 31 can be further configured to send a remote control instruction to the control base station 20 currently communicating with the UAV 10 to control the flight of the UAV 10 through the current control base station 20.

Specifically, the user inputs a remote control instruction through an external device (such as a laptop computer, a tablet computer, a mobile phone, and etc.) that communicates with the server 30, and the server 30 sends the remote control instruction to the control base station 20 currently communicating with the UAV 10, and then the base station forwards the remote control instruction to the UAV 10. Therefore, when the UAV 10 performs a task, the user can remotely control the UAV 10 to fly and shoot images or videos of the target area through the server 30. In some unpredicted weather, the user can remotely control the UAV 10 through the server 30 to return and land in time to ensure the safety of the UAV 10.

The present disclosure also provides a computer-readable storage medium that stores a computer program to be used together with an electronic device. One part of the computer program can be executed by the first processor 12, and the other part of the computer program can be executed by the second processor 32 to implement the control method described in the above embodiments to control the UAV 10 by at least two control base stations 20. The electronic device is the UAV 10 and the server 30.

For example, the computer program can be executed by the first processor 12 to implement the control methods by reading the position information of the second control base station 22 from the first communication circuit 11 by the first processor 12 of the UAV 10, determining that the distance between the UAV 10 and the second control base station 22 is shorter than the distance between the UAV 10 and the first control base station 21, and controlling the first communication circuit 11 to establish a communication with the second control base station 22.

For another example, the computer program can be executed by the first processor 12 to perform the control method by reading the position information of the first control base station 21 from the first communication circuit 11 by the first processor 12 of the UAV 10, obtaining the position of the UAV 10 from the sensor, calculating the distance between the UAV 10 and the first control base station 21 based on the position information of the UAV 10 and the position information of the first control base station 21, and calculating the distance between the UAV 10 and the second control base station 22 based on the position information of the UAV 10 and the position information of the second control base station 22.

For another example, the computer program can be executed by the second processor 32 to perform the control method by controlling the second communication circuit 31 through the second processor 32 of the server 30 to receive the result that the distance between the UAV 10 and the second control base station 22 is shorter than the distance between the UAV 10 and the first control base station 21, receiving information about the communication state of the UAV 10 being switched from communicating with the first control base station 21 to communicating with the second control base station 22, and switching the data source from the first control base station 21 to the second control base station 22.

For another example, the computer program can also be executed by the second processor 32 to perform the control method by controlling the second communication circuit 31 to receive the acquisition instruction forwarded by the first control base station 21 to acquire the position information of the second control base station 22 and sending the position information of the second control base station 22 to the UAV 10. The acquisition instruction is sent by the UAV 10 to the first control base station 21.

In this disclosure, the description with reference to a term like “one embodiment,” “some embodiments,” “schematic embodiments,” “examples,” “specific examples,” or “some examples” or the like means that specific features, structures, materials, or characteristics described in the embodiments or examples are included in at least one embodiment or example of the present disclosure. In this disclosure, the schematic expressions of the above terms do not necessarily refer to the same embodiments or examples. Further, the specific features, structures, materials, or characteristics described may be combined in any suitable manner in any one or more embodiments or examples.

Any process or method described in a flowchart or otherwise herein can be a module, fragment, or portion of code that includes one or more executable instructions for performing a particular logical function or a process.

The scope of the embodiments of this disclosure includes other embodiments, in which the functions may be performed out of the order shown or discussed, including performing the functions in a substantially simultaneous manner or in the reverse order according to the functions involved. This should be understood by those skilled in the art.

The logic and/or steps described in a flowchart or otherwise described herein, for example, a sequenced list of executable instructions to perform a logical function, can be embodied in any computer-readable medium to be used by the instruction executing systems or devices (such as a computer-based system, a system including a processor, or other system that can read and execute instructions from the instruction executing systems or devices), or to be integrated with these instruction executing systems or devices. In this disclosure, a “computer-readable medium” can be any device that contains, stores, communicates, and transmits a computer program for use by instruction executing systems and devices, or being integrated with the instruction executing systems or devices. Some examples computer readable medium (non-exhaustive list) include electrical connections with one or multiple wirings (electronic devices), portable computer disk cartridges (magnetic devices), random access memory (RAM), Read-only memory (ROM), erasable programmable read-only memory (EPROM or flash memory), fiber optic devices, and compact disk read-only memory (CD-ROM). In addition, the computer-readable medium can even be paper or other suitable medium on which the program can be printed, because, by optically scanning the paper or other medium, followed by editing, interpretation, or other suitable processing to, the electronic program can be obtained and stored in computer memory.

Each part of this disclosure can be performed by hardware, software, or a combination thereof. In the above embodiments, multiple steps or methods can be performed by software stored in a memory and executed by a suitable instruction executing system or hardware. For example, if performed by hardware, it can be executed by any one or a combination of the following techniques: a discrete logic circuit having a logic gate circuit for performing a logic function on a data signal, an application-specific integrated circuit with suitable combinational logic gate circuits, a programmable gate array (PGA), a field-programmable gate array (FPGA), etc.

Those skilled in the art can understand that all or some of the processes described in the above embodiments can be implemented by a computer program instructing related hardware. The computer program can be stored in a computer-readable storage medium. One or a combination of the steps of the methods in the embodiments can be implemented by the computer program.

In addition, the functional units in the various embodiments of the present disclosure may be integrated in one processing unit, or each unit may be an individual physically unit, or two or more units may be integrated in one unit. The above integrated modules can be implemented in the form of hardware or software functional modules. When the integrated module is performed in the form of computer program stored in a computer-readable storage medium, it can be sold or used as a standalone product.

The storage medium mentioned above can be a read-only memory (ROM), a magnetic disk or an optical disk. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for controlling an unmanned aerial vehicle (UAV) in communication with a first control base station comprising:
obtaining position information of a second control base station;
determining that a distance between the UAV and the second control base station is shorter than a distance between the UAV and the first control base station; and
establishing a communication with the second control base station.

2. The method of claim 1, further comprising:
obtaining position information of the first control base station;
obtaining position information of the UAV; and
calculating the distance between the UAV and the first control base station based on the position information of the UAV and the position information of the first control base station, and calculating the distance between the UAV and the second control base station based on the position information of the UAV and the position information of the second control base station.

3. The method of claim 2, wherein the position information of the first control base station includes coordinates of the first control base station, the position information of the second control base station includes coordinates of the second control base station, and the position information of the UAV includes coordinates of the UAV.

4. The method of claim 3, wherein:
calculating the distance between the UAV and the first control base station based on the position information of the UAV and the position information the first control base station includes calculating a distance between the coordinates of the UAV and the coordinates of the control base station; and
calculating the distance between the UAV and the second control base station based on the position information of the UAV and the position information of the second control base station includes calculating a distance between the coordinates of the UAV and the coordinates of the second control base station.

5. The method of claim 1, wherein obtaining the position information of the second control base station includes:
sending an acquisition instruction for acquiring the position information of the second control base station to the first control base station; and
receiving the position information of the second control base station sent by the first control base station according to the acquisition instruction.

6. The method of claim 5, wherein:
the position information of the second control base station is stored in a server that communicates with the first control base station and the second control base station; and
the position information of the second control base station received by the UAV is obtained from the server and forwarded to the UAV by the first control base station according to the acquisition instruction.

7. The method of claim 1, wherein the position information of the second control base station is stored in the UAV.

8. The method of claim 1, wherein establishing the communication with the second control base station includes:
sending a communication request for establishing the communication to the second control base station; and
establishing the communication with the second control base station in response to receiving an agreement from the second control base station.

9. The method of claim 1, wherein establishing the communication with the second control base station includes:
receiving a communication request for establishing the communication sent by the second control base station; and
establishing the communication with the second control base station in response to the UAV agreeing to establish the communication.

10. The method of claim 1, wherein establishing the communication with the second control base station includes:
receiving a communication request for establishing the communication sent by the second control base station;
sending a switching request to the first control base station;
receiving a consent response from the first control base station; and
sending an agreement response to the second control base station.

11. The method of claim 1, further comprising, in response to a failure of attempting to establish the communication between the UAV and the second control base station:
obtaining position information of a third control base station; and
determining that a distance between the UAV and the third control base station is shorter than a distance between the UAV and the first control base station; and
establishing a communication with the third control base station.

12. The method of claim 11, further comprising, in response to a failure of attempting to establish the communication between the UAV and the third control base station:
controlling the UAV to execute a return-home operation.

13. A method for controlling an unmanned aerial vehicle (UAV) comprising:
receiving information indicating that a distance between the UAV and a first control base station is greater than a distance between the UAV and a second control base station;
receiving information about a communication state of the UAV being switched from communicating with the first control base station to communicating with the second control base station; and
switching a data source from the first control base station to the second control base station.

14. The method of claim 13, further comprising:
sending position information of the second control base station to the UAV.

15. The method of claim 14, further comprising:
receiving, from the first control base station, an acquisition instruction for acquiring the position information of the second control base station, the acquisition instruction being sent to the first control base station by the UAV.

16. The method of claim 13, further comprising:
receiving data information sent by a currently-communicating control base station that is currently-communicating with the UAV, the currently-communicating control base station being one of the first control base station and the second control base station, and the data information being sent to the currently-communicating control base station by the UAV.

17. The method of claim 16, wherein the data information includes at least one of a parameter of the UAV, parameter information of a load carried by the UAV, or environmental information obtained by the UAV through the load.

18. The method of claim 13, further comprising:
sending a remote control instruction to the second control base station to control flight of the UAV via the second control base station.

19. An unmanned aerial vehicle (UAV) in communication with a first control base station comprising:
a communication circuit configured to obtain position information of a second control base station; and
a processor configured to determine that a distance between the UAV and the second control base station is shorter than a distance between the UAV and the first control base station;
wherein the communication circuit is further configured to establish a communication with the second control base station.

20. A server comprising:
a communication circuit configured to:
receive information indicating that a distance between an unmanned aerial vehicle (UAV) and a first control base station is greater than a distance between the UAV and a second control base station;
receive information indicating that a communication state of the UAV is switched from communicating with the first control base station to communicating with the second control base station; and
switch a data source from the first control base station to the second control base station.
